(19) United States
(12) Patent Application Publication
(10) Pub. No.: US 2012/0185932 A1
(43) Pub. Date: Jul. 19, 2012

(54) Sensing and Secure Processing

(75) Inventors: Keld Stougaard, Karlslunde (DK); Jacob Berlin Rasmussen, Valby (DK)

(73) Assignee: NOKIA CORPORATION, Espoo (FI)

(21) Appl. No.: 13/386,901

(22) PCT Filed: Jul. 24, 2009
(86) PCT No.: PCT/EP2009/059615

§ 371 Date: Apr. 3, 2012

(51) Int. Cl. G06F 21/00

(52) U.S. Cl. 726/16

(57) ABSTRACT

A first and second apparatuses, first and second computer programs and first and second methods are provided. The first apparatus comprises: an interface; and a secure processor configured to control the interface to provide a request, to the second apparatus, requesting information from one or more sensors of the second apparatus. The request may be a data structure comprising an element having one of a multiplicity of predetermined configurations, each configuration identifying at least one of a plurality of sensors. The second apparatus comprises: a further interface; one or more sensors; and a processor configured to receive via the further interface the request, from the secure processor of first apparatus, requesting information from at least one sensor identified in the request. The processor is configured to process the request, to determine whether the second apparatus comprises the at least one sensor identified in the request.

### FIELD

Embodiments of the present invention relate to sensing and secure processing. In particular, they relate to sensing information and providing sensed information to a secure processor.

### BACKGROUND

A smart card (such as a subscriber identity module) may be used in conjunction with a mobile radio telephone to provide access to a radio telephone network.

### BRIEF DESCRIPTION OF VARIOUS EMBODIMENTS OF THE INVENTION

According to various, but not necessarily all embodiments of the invention, there is provided an apparatus, comprising: an interface; and a secure processor configured to control the interface to provide a request, to a further apparatus, requesting information from one or more sensors of the further apparatus, wherein the request is a data structure comprising an element having one of a multiplicity of predetermined configurations, each configuration identifying at least one of a plurality of sensors.

The secure processor may be configured to receive, via the interface, the information from the further apparatus. The secure processor may be configured to receive an identifier that enables the secure processor to determine that the information from the further apparatus is provided in response to the request.

The secure processor may be configured to process the information to produce a secure result. The secure processor may be configured to perform an action, in dependence upon the secure result.

The data structure may further comprise a further element indicating when the information is to be provided to the apparatus by the further apparatus. The further element may instruct the further apparatus to provide the information to the apparatus contemporaneously upon receipt of the request. The further element may instruct the further apparatus to provide the information in response to the occurrence of one or more events.

The apparatus may be a smart card. The further apparatus may be a hand-portable electronic device.

According to various, but not necessarily all embodiments of the invention, there is provided a method, comprising: controlling an interface using a secure processor, to provide a request, to an apparatus, for requesting information from one or more sensors of the apparatus, wherein the request is a data structure comprising an element having one of a multiplicity of predetermined configurations, each configuration identifying at least one of a plurality of sensors.

According to various, but not necessarily all embodiments of the invention, there is provided a computer program comprising instructions which, when executed by a processor, enable: controlling an interface using a secure processor, to provide a request, to an apparatus, requesting information from one or more sensors of the apparatus, wherein the request is a data structure comprising an element having one of a multiplicity of predetermined configurations, each configuration identifying at least one of a plurality of sensors.

According to various, but not necessarily all embodiments of the invention, there is provided an apparatus, comprising: interface means; and secure processing means for controlling the interface means to provide a request, to a further apparatus, requesting information from one or more sensors of the further apparatus, wherein the request is a data structure comprising an element having one of a multiplicity of predetermined configurations, each configuration identifying at least one of a plurality of sensors.

According to various, but not necessarily all embodiments of the invention, there is provided an apparatus, comprising: an interface; one or more sensors; and a processor configured to receive via the interface a request, from a secure processor of another apparatus, requesting information from at least one sensor identified in the request, and the processor being configured to process the request, to determine whether the apparatus comprises the at least one sensor identified in the request.

The processor may be configured, in response to determining that the apparatus comprises the at least one sensor identified in the request, to control the interface to provide, to the another apparatus, information from the identified at least one sensor.

The processor may be configured to control the interface to provide, to the another apparatus, an identifier for enabling the secure processor to determine that the information is being provided in response to the request.

The request may a data structure comprising an element having one of a multiplicity of predetermined configurations. Each configuration may identify at least one of a plurality of sensors. The processor may be configured to process the element to determine whether the apparatus comprises the at least one of a plurality of sensors identified by the element.

The request may comprise a further element indicating when the information is to be provided to the another apparatus by the apparatus.

The processor may be configured, in response to determining that the apparatus comprises at least one sensor identified by the element, to obtain contemporaneous information from the identified at least one sensor of the apparatus, and to provide the contemporaneous information to the another apparatus.

The processor may be configured, in response to determining that the apparatus comprises the at least one sensor identified by the element, to monitor the identified at least one sensor. The processor may be configured, in response to determining that an identified sensor is in a particular one of a plurality of states, to provide the information to the another apparatus.

The apparatus may be a hand-portable electronic device. The another apparatus may be a smart card.

According to various, but not necessarily all embodiments of the invention, there is provided a method, comprising: receiving at an apparatus a request, from a secure processor of another apparatus, requesting information from at least one sensor identified in the request; and processing the request, to determine whether the apparatus comprises the at least one sensor identified in the request.

According to various, but not necessarily all embodiments of the invention, there is provided a computer program comprising instructions which, when executed by a processor, enable: receiving at an apparatus a request, from a secure processor of another apparatus, requesting information from at least one sensor identified in the request; and processing the request, to determine whether the apparatus comprises the at least one sensor identified in the request.

According to various, but not necessarily all embodiments of the invention, there is provided an apparatus, comprising: interface means; one or more sensing means; and processing means for receiving via the interface means a request, from a secure processor of another apparatus, requesting information from at least one sensing means identified in the request, and the processing means being for processing the request, to determine whether the apparatus comprises the at least one sensing means identified in the request.

### BRIEF DESCRIPTION OF THE DRAWINGS

For a better understanding of various examples of embodiments of the present invention reference will now be made by way of example only to the accompanying drawings in which:

FIG. 1 illustrates an exemplary first apparatus;

FIG. 2 illustrates an exemplary second apparatus;

FIG. 3A illustrates a request;

FIG. 3B illustrates a response to the request;

FIG. 4 schematically illustrates a flow chart of a first method;

FIG. 5 illustrates exemplary first and second apparatuses operationally coupled together;

FIG. 6 schematically illustrates a flow chart of a second method;

FIG. 7 schematically illustrates a flow chart of a third method;

FIG. 8 illustrates exemplary alternative first and second apparatuses operationally coupled together; and

FIG. 9 illustrates further exemplary alternative first and second apparatuses operationally coupled together.

### DETAILED DESCRIPTION OF VARIOUS EXEMPLARY EMBODIMENTS OF THE INVENTION

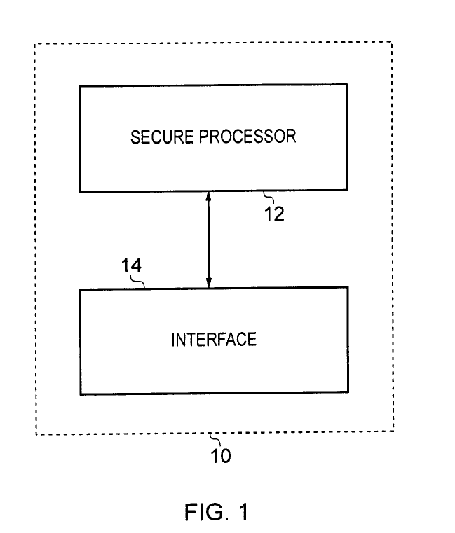

FIG. 1 illustrates a first apparatus 10. The first apparatus 10 may be a secure element in the form of a chip or a chipset. The chip or chip-set may or may not be for use in a smart card. Alternatively, the first apparatus 10 may be a smart card. The smart card may, for instance, be substantially planar and have a rectangular shape. In some embodiments of the invention, the smart card is a universal integrated circuit card (UICC). In these embodiments, the UICC may provide access to a mobile radio telephone network.

The first apparatus 10 may, for example, operate in accordance with one or more standards relating to the SIM (Subscriber Identity Module) Application Toolkit and/or the USIM (Universal Subscriber Identity Module) Application Toolkit.

The first apparatus 10 illustrated in FIG. 1 comprises a secure processor 12 and an interface 14. The secure processor 12 may be considered to be “secure” because it is tamper-resistant and/or because data processed by the secure processor 12 is encrypted. Tamper resistivity of the secure processor 12 may be provided by the physical/mechanical properties of the secure processor 12 and/or the physical/mechanical properties of a housing of the first apparatus 10.

The implementation of the secure processor 12 can be in hardware alone (a circuit, processing circuitry . . . ), have certain aspects in software including firmware alone or can be a combination of hardware and software (including firmware).

The secure processor 12 is configured to control the interface 14 to output data to another apparatus. The secure processor 12 may also be configured to receive data from another apparatus via the interface 14. The interface 14 may operate in accordance with one or more standards. For example, the interface 14 may operate in accordance with an ISO (International Organization for Standardization) 7816 standard or a Universal Serial Bus (USB) standard.

The secure processor 12 and the interface 14 are operationally coupled and any number or combination of intervening elements can exist between them (including no intervening elements).

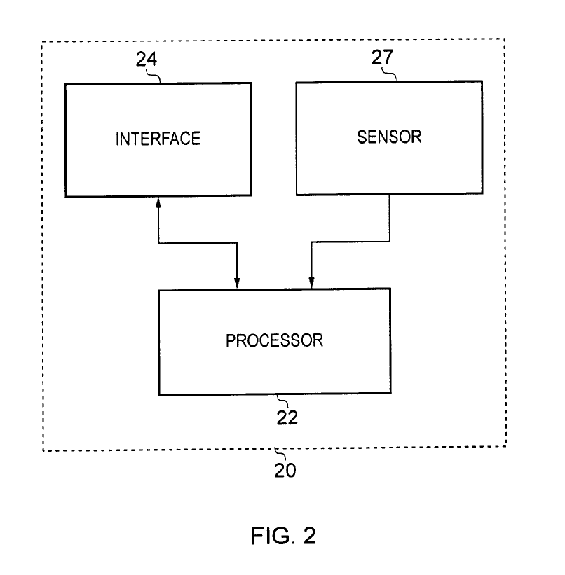

FIG. 2 illustrates a second apparatus 20. The second apparatus 20 may, for example, be a hand-portable electronic device. Alternatively, the second apparatus 20 may be a chip or a chipset for a hand-portable electronic device. In some embodiments of the invention, the hand-portable electronic device is a mobile radio telephone.

The second apparatus 20 may, for example, operate in accordance with one or more standards relating to the SIM Application Toolkit and/or the USIM Application Toolkit.

The second apparatus 20 illustrated in FIG. 2 comprises a processor 22, an interface 24 and a sensor 27. The processor 22 is configured to receive data from another apparatus (such as the first apparatus 10) via the interface 24. The processor 22 may be configured to control the interface 24 to provide data to another apparatus.

The implementation of the processor 22 can be in hardware alone (a circuit, processing circuitry . . . ), have certain aspects in software including firmware alone or can be a combination of hardware and software (including firmware).

The interface 24 may operate in accordance with one or more standards. For example, the interface 24 may operate in accordance with an ISO 7816 standard or a USB standard.

The sensor 27 is configured to sense information. The sensor 27 may, for example, be configured to sense information from the external environment of the second apparatus 20. The processor 22 is configured to receive information sensed by the sensor 27.

Although the second apparatus 20 is illustrated in FIG. 2 as comprising a single sensor 27, in practice the second apparatus 20 may comprise a plurality of sensors. The sensors may be any type of sensors. The sensors may, for example, include a proximity sensor and/or one or more biometric sensors.

The processor 22 is operationally coupled to the interface 24 and the sensor 27. Any number or combination of intervening elements can exist between the processor 22 and the interface 24, and between the processor 22 and the sensor 27 (including no intervening elements).

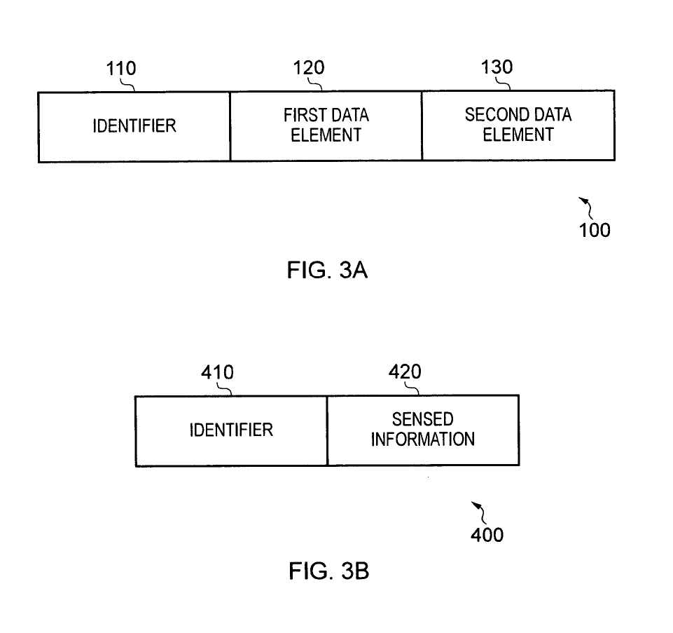

FIG. 3A illustrates a request 100. The request 100 is a data structure that comprises an identifier 110, a first data element 120 and a second data element 130. The identifier 110 may, for instance, be a code that identifies the request 100.

The first data element 120 may indicate to the recipient of the request that information is being requested from the recipient. The first data element 120 may also indicate to the recipient when the information is to be provided in response to the request 100.

The second data element 130 may qualify the first data element 120 by specifying the type of information that is being requested by the sender, and/or the source from which the information is requested. The second data element 130 may have one of a multiplicity of different configurations. In this example, each and every one of the configurations indicates that sensor information is being requested by the sender. Each different configuration identifies a particular sensor or combination of sensors. For example, one configuration may identify a proximity sensor. Another configuration may identify a biometric sensor. A further configuration may identify a plurality of sensors including, for example, a proximity sensor and a biometric sensor.

In some embodiments of the invention, the first data element 120 may indicate that (current) information is to be provided to the sender of the request 100 contemporaneously upon receipt of the request 100 (for example, immediately).

In other embodiments of the invention, the first data element 120 may indicate that the information is to be provided to the sender of the request 100 in response to the occurrence of a particular event or events. In these embodiments, the configuration of the second data element 130 may specify the event or events. For example, the second data element 130 may specify that information is to be provided when a sensor (or sensors) is in a particular one of a plurality of possible states.

For example, consider a situation where a sensor identified in the second data element 130 is a proximity sensor. This particular proximity sensor may be considered to have two states: a “false” state, where a proximal object has not been detected, and a “true” state where a proximal object has been detected. The configuration of the second data element 130 may indicate to the recipient of the request 100 that, following receipt of the request, the recipient is to respond to the request 100 when the proximity sensor is in the “true state”. If the proximity sensor is currently is the “true” state, an immediate response to the request may be provided to the sender. If the proximity sensor is currently in the “false” state, a response to the request is provided if and when the proximity sensor enters the “true” state.

FIG. 3B illustrates a response 400 to the request 100. The response 400 comprises an identifier 410 and sensed information 420. The identifier 410 of the response 400 may, for instance, comprise the same code as that included in a corresponding request 100. Upon receiving a response 400, an apparatus may determine that the response 400 corresponds to a particular request 100 by comparing the identifier 410 with the identifier 110 that was included in the request 100.

The sensed information 420 may include information that has been sensed by one or more sensors. The information may take a variety of different forms. For example, in some embodiments of the invention, sensed information 420 obtained from a proximity sensor may merely be an indication of whether an object is located close to the proximity sensor or not (for instance, a true/false indication). In other embodiments of the invention, more detail may be provided. For example, the sensed information 420 may provide an indication of the distance from the proximity sensor to the object.

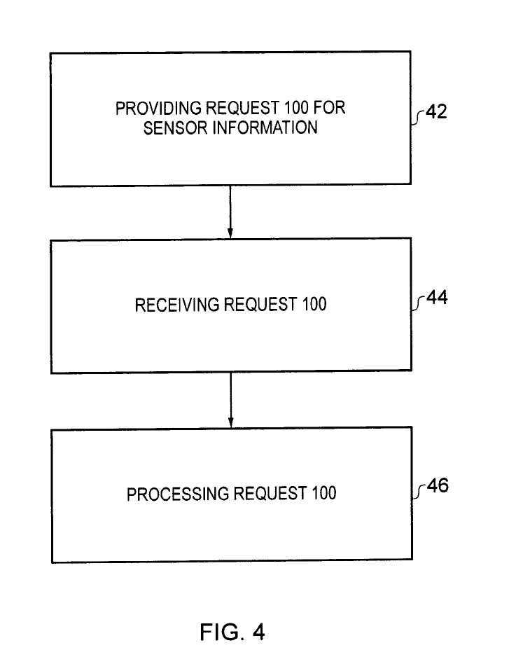

A first exemplary method according to embodiments of the invention will now be described in relation to FIG. 4.

The secure processor 12 of the first apparatus 10 may generate the request 100. In this example, the first apparatus 10 and the second apparatus 20 are operationally coupled via their respective interfaces 14, 24. At block 42 of FIG. 4, the secure processor 12 controls the interface 14 of the first apparatus 10 to provide the request 100 to the processor 22 of the second apparatus 20.

At block 44 of FIG. 4, the processor 22 of the second apparatus 20 receives the request 100. At block 46 of FIG. 4, the processor 22 of the second apparatus 20 processes the first and second data elements 120, 130 of the request 100. The processor 22 determines whether the second apparatus 20 comprises any of the sensors identified by the configuration of the second data element 130. This may be done, for example, by comparing the configuration of the second data element 130 (or portions of it) with entries in a look up table stored in a memory of the second apparatus 20.

If the processor 22 determines that the second apparatus 20 does not comprise any of the sensors identified by the configuration of the second data element 130, the processor 22 may control the interface 24 to provide a null response to the first apparatus 10.

If the processor 22 determines that the second apparatus 20 comprises at least one of the sensors identified by the configuration of the second data element 130, the processor 22 may obtain information from that/those sensor/sensors. In some embodiments of the invention, the processor 22 obtains current information (a current reading) from the relevant sensor(s). In these embodiments, the processor 22 may activate the relevant sensor(s) in order to obtain the current information. In other embodiments of the invention, the processor 22 obtains information recently obtained from the relevant sensor(s) and stored in a memory register.

The processor 22 may generate a response 400 to the request 100 that comprises an identifier 410 matching the identifier 110 included in the received request 100 and information 420 sensed by the relevant sensor(s). The processor 22 may the control the interface 24 of the second apparatus to provide the response 400 to the secure processor 12 of the first apparatus 10.

After receiving the response 400, the secure processor 12 may process the sensed information 420, along with other information, to produce a secure result. In some embodiments of the invention, the secure processor 12 may perform an action, in dependence upon the secure result.

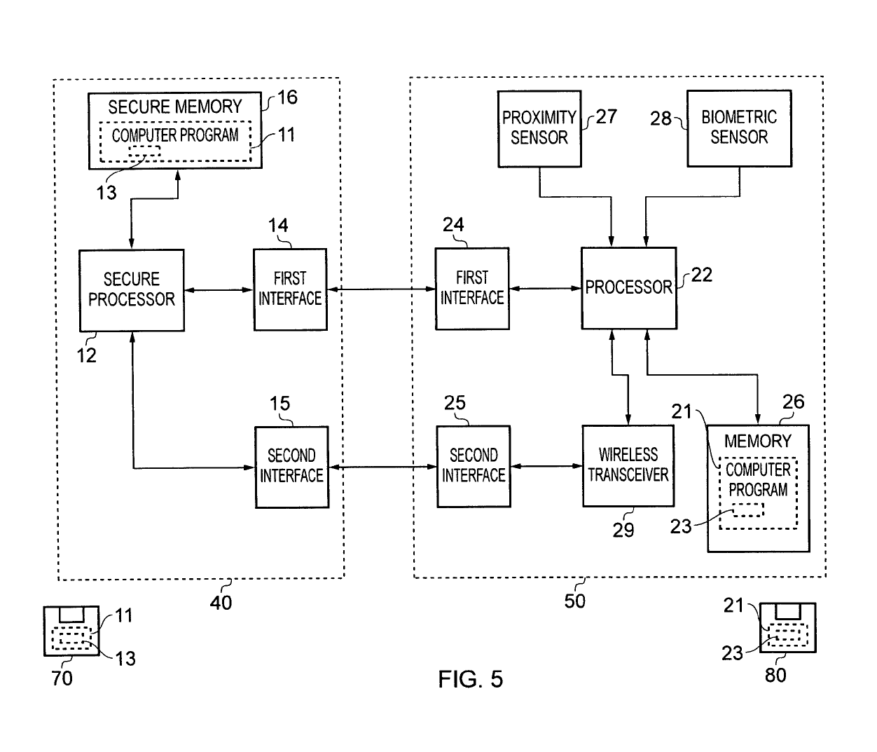

FIG. 5 illustrates an exemplary first apparatus 40 operationally coupled to an exemplary second apparatus 50. The first apparatus 40 and the second apparatus 50 illustrated in FIG. 5 may, for example, operate in accordance with one or more standards relating to the SIM Application Toolkit and/or the USIM Application Toolkit.

The first apparatus 40 illustrated in FIG. 5 differs from that illustrated in FIG. 1 in that it comprises a secure memory 16 and a second interface 15. The secure processor 12 may be configured to control the second interface 15 to output data. The secure processor 12 may also be configured to receive data via the second interface 15. The second interface 15 may, for example, operate in accordance with a single wire protocol (SWP).

The secure memory 16 may be considered to be “secure” because it is tamper-resistant and/or because data stored by the secure memory 16 is encrypted. Tamper resistivity of the secure memory 16 may be provided by the physical/mechanical properties of the secure memory 16 and/or the physical/mechanical properties of a housing of the first apparatus 40.

The secure memory 16 is illustrated as storing a computer program 11 comprising computer program instructions 13 that, when loaded into the secure processor 12, control the operation of the first apparatus 40. The computer program instructions 13 provide the logic and routines that enables the first apparatus 40 to perform aspects of the methods illustrated in FIGS. 4, 6 and 7. The secure processor 12 by reading the secure memory 16 is able to load and execute the computer program 11.

The computer program 11 may arrive at the first apparatus 40 via any suitable delivery mechanism 70. The delivery mechanism 70 may be, for example, a computer-readable storage medium, a computer program product, a memory device, a record medium such as a CD-ROM or DVD, an article of manufacture that tangibly embodies the computer program 11. The delivery mechanism 70 may be a signal configured to reliably transfer the computer program 11. The first apparatus 40 may propagate or transmit the computer program 11 as a computer data signal.

Although the secure memory 16 is illustrated in FIG. 5 as a single component it may be implemented as one or more separate components some or all of which may be integrated/removable and/or may provide permanent/semi-permanent/dynamic/cached storage.

The second apparatus 50 illustrated in FIG. 5 differs from that illustrated in FIG. 2 in that it comprises a second interface 25, a memory 26, a proximity sensor 27, a biometric sensor 28 and a wireless transceiver 29.

It will be appreciated by those skilled in the art that the second apparatus 50 may comprise other sensors in addition to (or as alternatives to) the proximity sensor 27 and the biometric sensor 28. The biometric sensor 28 may, for example, be a fingerprint scanner, an iris scanner or a voiceprint reader.

The processor 22 is configured to receive an input from and provide an output to the wireless transceiver 29. The wireless transceiver 29 may, for example, be a near field communication (NFC) transceiver.

The wireless transceiver 29 is configured to receive an input from another apparatus (such as the first apparatus 40) via the second interface 25 and configured to control the second interface 25 to provide an output to the first apparatus 40. The second interface 25 may, for example, operate in accordance with a single wire protocol (SWP).

The memory 26 is illustrated as storing a computer program 21 comprising computer program instructions 23 that, when loaded into the processor 22, control the operation of the second apparatus 50. The computer program instructions 23 provide aspects of the logic and routines that enables the second apparatus 50 to perform the methods illustrated in FIG. 4, 6 or 7. The processor 22 by reading the memory 26 is able to load and execute the computer program 21.

The computer program 21 may arrive at the second apparatus 50 via any suitable delivery mechanism 80. The delivery mechanism 80 may be, for example, a computer-readable storage medium, a computer program product, a memory device, a record medium such as a CD-ROM or DVD, an article of manufacture that tangibly embodies the computer program 21. The delivery mechanism may be a signal configured to reliably transfer the computer program 21. The second apparatus 50 may propagate or transmit the computer program 21 as a computer data signal.

Although the memory 26 is illustrated as a single component it may be implemented as one or more separate components some or all of which may be integrated/removable and/or may provide permanent/semi-permanent/dynamic/cached storage.

FIG. 5 illustrates an “in use” scenario, where the first interfaces 14, 24 and the second interfaces 15, 25 of the first and second apparatuses 40, 50 are operationally coupled.

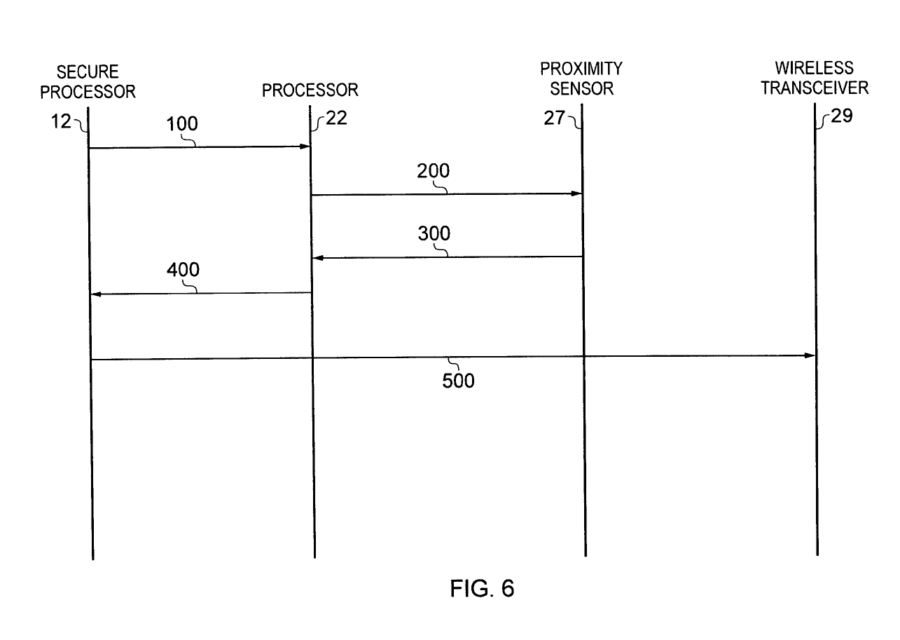

An exemplary second method according to embodiments of the invention will now be described with reference to FIG. 6.

The secure processor 12 of the first apparatus 40 generates a request 100 that has the same form as the request illustrated in FIG. 3A. In this example, the request 100 is a command.

In this example, the command 100 is a PROVIDE LOCAL INFORMATION command. The first data element 120 identifies the command 100 as a PROVIDE LOCAL INFORMATION command, indicating that the first apparatus 40 wishes to receive current information.

The second data element 130 is a “SENSORS” command qualifier which has a configuration identifying a proximity sensor. The combination of the first and second data elements 120, 130 therefore indicate that current information from a proximity sensor is requested.

The secure processor 12 controls the first interface 14 of the first apparatus 14 to provide the generated PROVIDE LOCAL INFORMATION command 100 to the processor 22 of the second apparatus 50.

The processor 22 of the second apparatus 50 analyzes the first data element 120 to determine what type of command the command 100 is. The processor 22 identifies the command 100 as a PROVIDE LOCAL INFORMATION command with a SENSORS command qualifier 130, and concludes that the first apparatus 40 wishes to receive current information from any sensors identified in the SENSORS command qualifier 130.

The processor 22 analyzes the second data element 130 to determine whether the second apparatus 50 comprises any of the sensors identified by the configuration of the second data element 130. In this example, the processor 22 concludes that the second apparatus 50 comprises the proximity sensor 27 identified by the configuration of the second data element 130.

The processor 22 provides a signal 200 to the proximity sensor 27 to activate the proximity sensor 27. In response to receiving the signal, the proximity sensor 27 senses the external environment and obtains current information by determining that a proximal object is present in the external environment.

The processor 22 receives the current information, in the form of signal 300, from the proximity sensor 27. The processor 22 then generates a response 400 to the PROVIDE LOCAL INFORMATION command 100. The response 400 has the same form as that illustrated in FIG. 3B. In this example, the response 400 is a “TERMINAL RESPONSE” 400.

The TERMINAL RESPONSE 400 includes an identifier 410 that identifies the response as a response to the PROVIDE LOCAL INFORMATION command 100 and includes the sensed information 420 from the proximity sensor 27.

The processor 22 controls the first interface 24 of the second apparatus 50 to provide the TERMINAL RESPONSE 400 to the secure processor 12 of the first apparatus 40.

The secure processor 12 processes the TERMINAL RESPONSE 400 and determines from the processing that a proximal object is present. The secure processor 12 then controls the second interface 15 to provide a signal 500 to the wireless transceiver 29, instructing the wireless transceiver 29 to scan for wireless signals.

Embodiments of the invention may, advantageously, enable power to be conserved because the wireless transceiver 29 need not scan for wireless signals until it is determined that the second apparatus 50 is close to an object (such as an NFC target) providing wireless signals.

In an alternative example to that described above, the command 100 provided by the first apparatus 40 may be a SET UP EVENT LIST command rather than a PROVIDE LOCAL INFORMATION command.

The first data element 120 of the SET UP EVENT LIST command may indicate that information is to be provided to the sender of the request 100 in response to the occurrence of a particular event or events.

The second data element 130 of the SET UP EVENT LIST command may have a configuration that identifies the event or events and the relevant sensor(s). For example, the SET UP EVENT LIST command may indicate that the secure processor 12 is to be informed when the proximity sensor 27 is in a state which indicates that it has detected a proximal object is present in the external environment.

In this alternative example, the processor 22 of the second apparatus 50 does not provide a response 400 to the secure processor 12 until the proximity sensor 27 is in the aforementioned state.

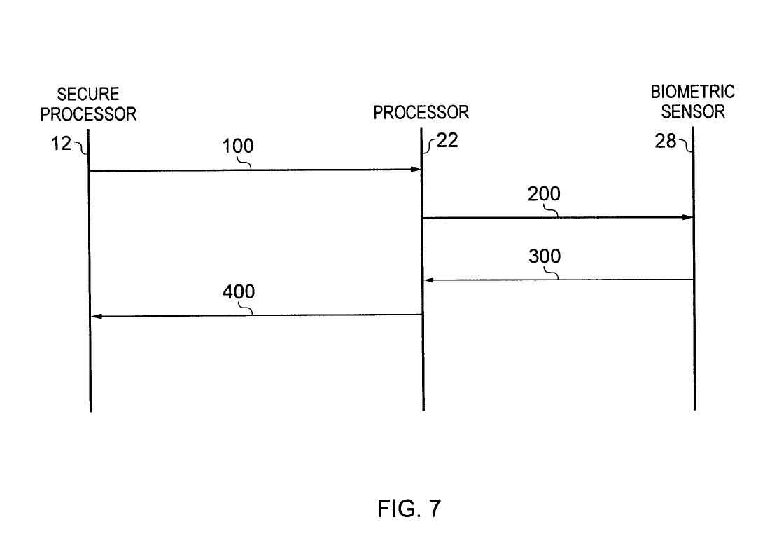

An exemplary third method according to embodiments of the invention will now be described with reference to FIG. 7.

The secure processor 12 of the first apparatus generates a request 100 that has the same form as the request illustrated in FIG. 3A. In this example, the request 100 is a command.

The command 100 may, for example, be a “PROVIDE LOCAL INFORMATION” command. In this example, the first data element 120 identifies the command 100 as a PROVIDE LOCAL INFORMATION command, indicating that the first apparatus 40 wishes to receive current information.

The second data element 130 is a “SENSORS” command qualifier which has a configuration identifying a biometric sensor. The combination of the first and second data elements 120, 130 therefore indicate that current information from a biometric sensor is requested.

The processor 22 of the second apparatus 50 analyzes the first data element 120 to determine what type of command the command 100 is. The processor 22 identifies the command 100 as a “PROVIDE LOCAL INFORMATION command” with a SENSORS command qualifier 130, and concludes that the first apparatus 40 wishes to receive current information from the biometric sensor identified in the SENSORS command qualifier 130.

The processor 22 determines that the second apparatus 50 comprises the biometric sensor 28 identified by SENSORS command qualifier 130. The processor 22 then provides a signal 200 to the biometric sensor 28 to activate it. In response to receiving the signal 200, the biometric sensor 28 senses the external environment and obtains current information by obtaining biometric information from an object such as a fingerprint or an iris.

The processor 22 receives the biometric information, in the form of signal 300, from the biometric sensor 28. The processor 22 then generates a response 400 to the PROVIDE LOCAL INFORMATION command 100. The response 400 has the same form as that illustrated in FIG. 3B. In this example, the response 400 is a “TERMINAL RESPONSE” 400.

The TERMINAL RESPONSE 400 comprises an identifier 410 that identifies the response as a response to the PROVIDE LOCAL INFORMATION command 100 and includes the sensed information 420 from the biometric sensor 28. The processor 22 controls the first interface 24 of the second apparatus 50 to provide the TERMINAL RESPONSE 400 to the secure processor 12 of the first apparatus 40.

The secure processor 12 of the first apparatus 40 may process the sensed information 420 by verifying at least some of the sensed information 420 against verification information stored in the secure memory 16. The result of the verification can be considered to be a “secure result”. In the event that verification is successful, the secure processor 12 may perform an action. For example, the secure processor 12 may not allow some functions to be performed by the first apparatus 40 unless successful verification is performed. After successful verification, the secure processor 12 may enable those functions to the performed.

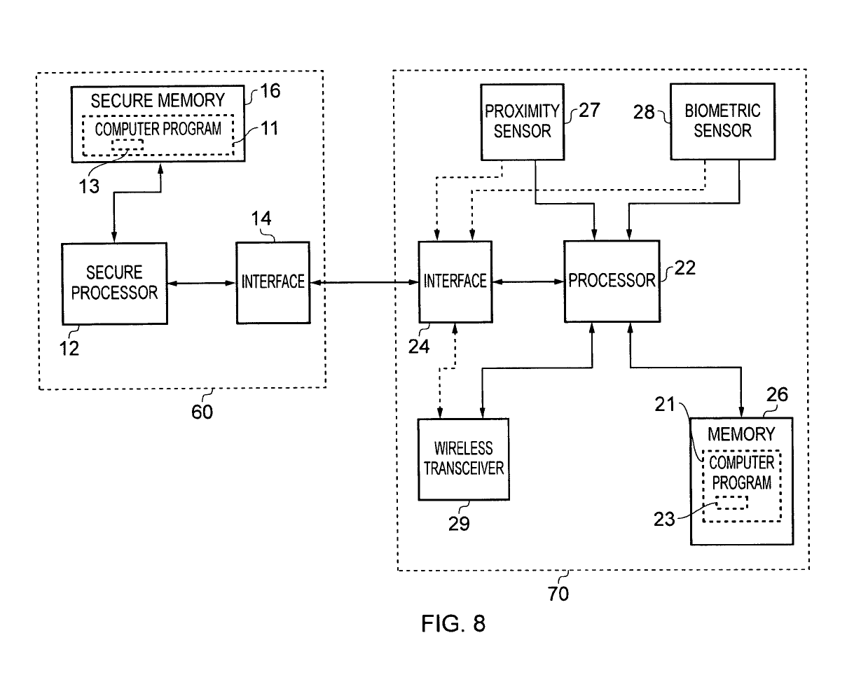

FIG. 8 illustrates an alternative first apparatus 60 and an alternative second apparatus 70 for carrying out the methods described above. The first apparatus 60 of FIG. 8 is the same as that illustrated in FIG. 5, other than that the secure processor 12 does not use a second interface 24 to communicate with the wireless transceiver 29.

The second apparatus 70 of FIG. 8 is the same as that illustrated in FIG. 5, other than that the wireless transceiver 29 does not use a second interface 25 to communicate with the secure processor 12.

In the FIG. 8 example, the secure processor 12 may use the interface 14 of the first apparatus 60 to communicate with the wireless transceiver 29 and the sensors 27, 28, via the processor 22. The wireless transceiver 29 may use the interface 24 of the second apparatus 70 to communicate with the secure processor 12. The interfaces 14, 24 of the first and second apparatuses 60, 70 may, for example, operate in accordance with the single wire protocol (SWP).

In some exemplary embodiments of the invention, the secure processor 12 may be able to address the sensors 27, 28 and the wireless transceiver 29 independently of the processor 22. This is illustrated by the dotted lines in FIG. 8. In these embodiments, the secure processor 22 may communicate with the sensors 27, 28 and the wireless transceiver 29 directly, rather than via the processor 22

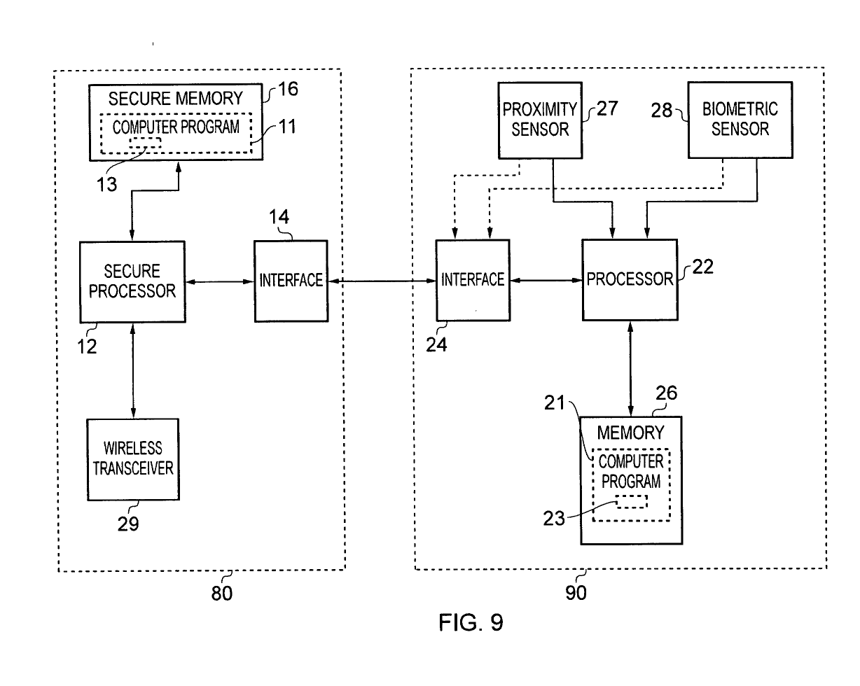

FIG. 9 illustrates an alternative first apparatus 80 and an alternative second apparatus 90 for carrying out the methods described above. The first and second apparatuses 80, 90 are the same as those illustrated in FIG. 8, other than that the wireless transceiver 29 is provided in the first apparatus 80 rather than the second apparatus 90.

References to ‘computer-readable storage medium’, ‘computer program product’, ‘tangibly embodied computer program’ etc. or a ‘secure processor’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

Aspects of the methods illustrated in FIGS. 4, 6 and 7 may represent sections of code in computer programs 11, 21. The illustration of a particular order does not necessarily imply that there is a required or preferred order to the method and the order may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed. For example, the first apparatus 10, 40, 60, 80 may obtain information from sensors that are different to those described above. For instance, in one alternative example, the secure processor 12 of the first apparatus 10, 40, 60, 80 may obtain a utility meter reading from a sensor of the second apparatus 20, 50, 70, 90 and instruct the second apparatus 20, 50, 70, 90 to transmit the reading to a remote location.

In another alternative example, the second apparatus 20, 50, 70, 90 may be a vending machine and the secure processor 12 may use a SET UP EVENT LIST command to determine when stock is running low in the vending machine. The secure processor 12 may instruct the second apparatus 20, 50, 70, 90 to transmit data to a remote location when stock is running low.

It will be apparent to those skilled in the art that the request 100 and the response 400 need not take the same form as that described above in some embodiments of the invention. For example, in some embodiments of the invention the request 100 and the response 400 may not include their respective identifiers 110, 410. In these embodiments of the invention, the secure processor 12 may treat a received response 400 as relating to the last request 100 that was sent by the first apparatus 10.

The sensor(s) of the second apparatus 20, 50, 70, 90 need not be for the exclusive use of the first apparatus 10, 40, 60, 80. In some embodiments of the invention, the sensor(s) may be used for functions that are independent of the first apparatus 10, 40, 60, 80. For instance, the processor 22 may use the proximity sensor 27 to determine whether to lock a user input device of the second apparatus 20, 50, 70, 90. If a proximal object is detected (as may be the case if the second apparatus 20, 50, 70, 90 is in the user's pocket, or in the user's hand while he is making a telephone call), the processor 22 may lock the user input device.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus, comprising:
an interface; and
a secure processor configured to control the interface to provide a request, to a further apparatus, requesting information from one or more sensors of the further apparatus, wherein the request is a data structure comprising an element having one of a multiplicity of predetermined configurations, each configuration identifying at least one of a plurality of sensors.

2. An apparatus as claimed in claim 1, wherein the secure processor is configured to receive, via the interface, the information from the further apparatus.

3. An apparatus as claimed in claim 2, wherein the secure processor is configured to receive an identifier that enables the secure processor to determine that the information from the further apparatus is provided in response to the request,
or wherein the secure processor is configured to process the information to produce a secure result,
or wherein the secure processor is configured to perform an action, in dependence upon the secure result,
or wherein the data structure further comprises a further element indicating when the information is to be provided to the apparatus by the further apparatus,
or wherein the further element instructs the further apparatus to provide the information to the apparatus contemporaneously upon receipt of the request,
or wherein the further element instructs the further apparatus to provide the information in response to the occurrence of one or more events.

4-8. (canceled)

9. An apparatus as claimed in claim 3, wherein the apparatus is a smart card and the further apparatus is a hand-portable electronic device.

10. A method, comprising:
controlling an interface using a secure processor, to provide a request, to an apparatus, for requesting information from one or more sensors of the apparatus, wherein the request is a data structure comprising an element having one of a multiplicity of predetermined configurations, each configuration identifying at least one of a plurality of sensors.

11. A method as claimed in claim 10, further comprising: receiving the information from the apparatus.

12. A method as claimed in claim 11, further comprising: receiving an identifier that enables the secure processor to determine that the information from the apparatus is provided in response to the request,
or a method, further comprising: securely processing the information to produce a secure result,
or method wherein further comprising: performing an action, in dependence upon the secure result,
or a method wherein the data structure further comprises a further element indicating when the information is to be provided by the apparatus,
or a method wherein the further element instructs the apparatus to provide the information contemporaneously upon receipt of the request,
or a method, wherein the further element instructs the apparatus to provide the information in response to the occurrence of one or more events,
or a method wherein a smart card provides the request to the apparatus, and the apparatus is a hand-portable electronic device.

13-18. (canceled)

19. A computer program that, when executed by a processor, enables the method as claimed in claim 12 to be performed.

20. A computer program comprising instructions which, when executed by a processor, enable:
controlling an interface using a secure processor, to provide a request, to an apparatus, requesting information from one or more sensors of the apparatus, wherein the request is a data structure comprising an element having one of a multiplicity of predetermined configurations, each configuration identifying at least one of a plurality of sensors.

21-28. (canceled)

29. A tangible computer readable medium storing a computer program as claimed in claim 20.

30. An apparatus, comprising:
interface means; and
secure processing means for controlling the interface means to provide a request, to a further apparatus, requesting information from one or more sensors of the further apparatus, wherein the request is a data structure comprising an element having one of a multiplicity of predetermined configurations, each configuration identifying at least one of a plurality of sensors.

31-38. (canceled)

39. An apparatus as claimed in claim 20, wherein the apparatus is a hand-portable electronic device and the another apparatus is a smart card.

40-60. (canceled)
